(19) United States
(12) Patent Application Publication
(10) Pub. No.: US 2025/0266549 A1
(43) Pub. Date: Aug. 21, 2025

(54) VEHICLE

(71) Applicant: TOYOTA JIDOSHA KABUSHIKI KAISHA, Toyota-shi (JP)

(72) Inventor: Ryusuke BABA, Nagoya-shi (JP)

(73) Assignee: TOYOTA JIDOSHA KABUSHIKI KAISHA, Toyota-shi (JP)

(21) Appl. No.: 18/968,847

(22) Filed: Dec. 4, 2024

(30) Foreign Application Priority Data
Feb. 21, 2024 (JP) 2024-024889

(51) Int. Cl. H01M 50/242; B60L 50/64; B60R 16/023; B60R 16/033; H01M 50/204; H01M 50/249; H01M 50/262; H01M 50/503

(52) U.S. Cl. CPC H01M 50/242; B60R 16/0238; B60R 16/033; H01M 50/204; H01M 50/249; H01M 50/262; H01M 50/503; B60L 50/64; H01M 2220/20

(57) ABSTRACT

A battery module in which a plurality of battery cells is stacked, a lower case in which the battery module is housed and the battery module is fixed, a junction box disposed above the battery module, a first body member in which the lower case is fixed, a second body member in which the junction box is fixed, and a conductive member electrically connecting the battery module and the junction box, wherein the conductive member has a first connection portion connected to the battery module, a second connection portion connected to the junction box, and an intermediate portion connecting the first connection portion and the second connection portion, and the intermediate portion has lower rigidity than the first connection portion and the second connection portion.

### CROSS-REFERENCE TO RELATED APPLICATION

This application claims priority to Japanese Patent Application No. 2024-024889 filed on Feb. 21, 2024, incorporated herein by reference in its entirety.

### BACKGROUND

### 1. Technical Field

The disclosure relates to vehicles.

### 2. Description of Related Art

Japanese Patent No. 6167096 (JP 6167096 B) discloses a vehicle equipped with a battery pack. In the configuration described in JP 6167096 B, the battery pack is disposed below a floor panel, and a battery module and a junction box are fixed to a lower case inside a case of the battery pack.

### SUMMARY

In the configuration described in JP 6167096 B, the battery module and the junction box are fixed to the same rigid body (lower case). Therefore, there is a low risk of a relative stress being applied to a conductive member that electrically connects the battery module and the junction box. Another structure is also possible in which the junction box is fixed to a member different from the lower case. In this case, the battery module and the junction box are fixed to different rigid bodies. Therefore, when the battery module and the junction box vibrate relatively to each other, a stress applied to the conductive member may become excessive.

The present disclosure was made in view of the above circumstances, and an object of the present disclosure is to provide a vehicle that can reduce a relative stress that is applied to a conductive member connected to a junction box in a structure in which the junction box is fixed to a member different from a lower case.

A vehicle according to the present disclosure includes: a battery module composed of a stack of a plurality of battery cells;
a lower case that houses the battery module and to which the battery module is fixed;
a junction box disposed above the battery module;
a first body member to which the lower case is fixed; a second body member to which the junction box is fixed; and a conductive member that electrically connects the battery module and the junction box.
   The conductive member includes
a first connection portion connected to the battery module,
a second connection portion connected to the junction box, and
an intermediate portion connecting the first connection portion and the second connection portion.
   The intermediate portion has lower rigidity than the first connection portion and the second connection portion.

According to the present disclosure, a relative stress that is applied to the conductive member connected to the junction box can be reduced in the structure in which the junction box is fixed to a member different from the lower case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a vehicle according to an embodiment;

FIG. 2 is a diagram for explaining a structure in which a battery module and a junction box are connected by a conductive member;

FIG. 3 is a diagram for explaining a structure in which a junction box and an interface are connected by a conductive member;

FIG. 4 is a diagram illustrating a structure in which a vibration absorbing portion is a braid;

FIG. 5 is a diagram for explaining a conductive member on an output side;

FIG. 6 is a diagram for explaining a structure in which a conductive member is constituted by a busbar;

FIG. 7 is a diagram for explaining a configuration in which the vibration absorbing portion is slit-shaped; and

FIG. 8 is a diagram for explaining a structure in which the vibration absorbing portion has a constricted shape in the width direction.

### DETAILED DESCRIPTION OF EMBODIMENTS

Hereinafter, a vehicle according to an embodiment of the present disclosure will be described in detail. The present disclosure is not limited to the embodiments described below.

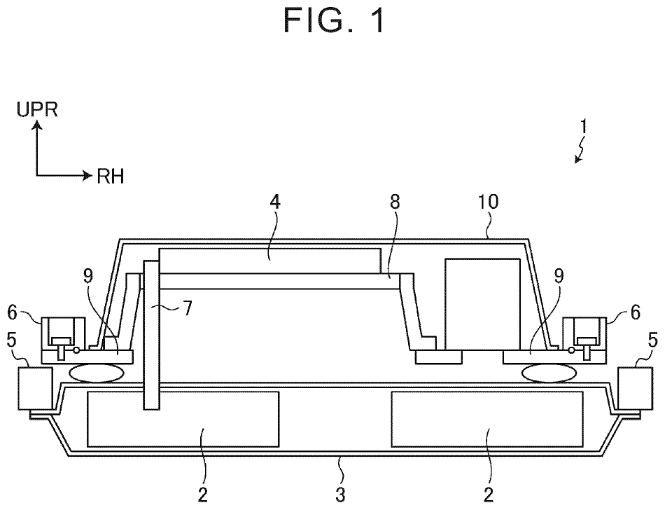

FIG. 1 is a diagram schematically illustrating a vehicle according to an embodiment. The vehicle 1 is an electrified vehicle equipped with a battery pack. The vehicle 1 has a structure in which a battery pack is disposed below a floor panel. The vehicle 1 includes battery modules 2, a lower case 3, a junction box 4, a first body member 5, a second body member 6, and a conductive member 7.

The battery pack of the vehicle 1 includes a plurality of battery modules 2, a lower case 3, and a junction box 4. The battery modules 2 are assembled batteries in which a plurality of battery cells are stacked. The lower case 3 houses the battery modules 2. The junction box 4 is disposed above the battery modules 2. The battery module 2 and the junction box 4 are electrically connected by a conductive member 7.

As shown in FIGS. 1 to 3, the lower case 3 is fixed to the first body member 5 and the second body member 6. The first body member 5 is a rocker provided on both sides in the width direction of the vehicle 1 and extending in the vehicle front-rear direction. The second body member 6 is a body member constituting a rear portion of the vehicle 1. For example, the second body member 6 is a metal member integrally formed by gigacasting. The lower case 3 is bolted to the first body member 5 on both sides in the vehicle width direction, and a rear portion in the vehicle front-rear direction is bolted to the second body member 6.

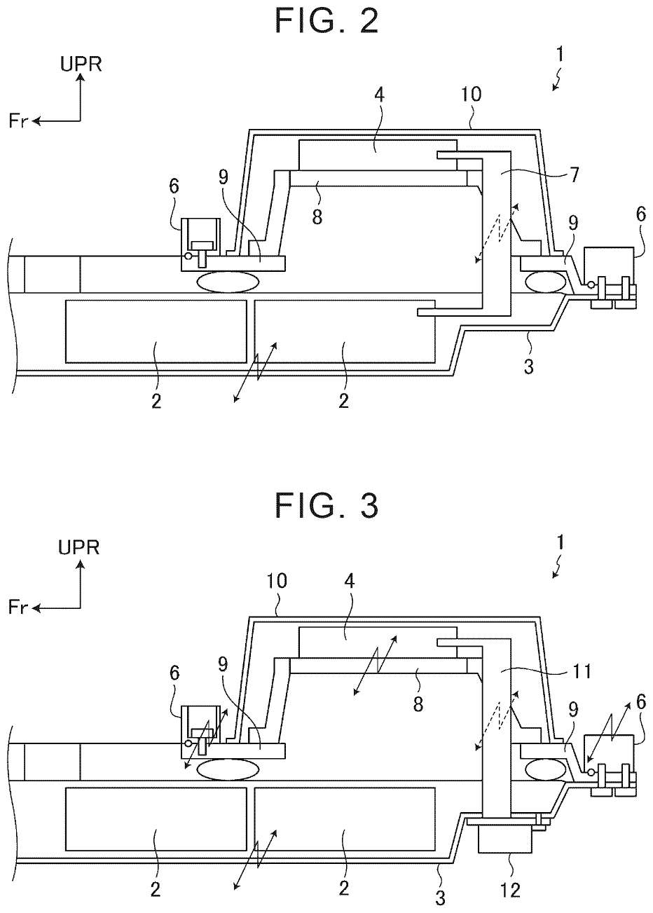

The junction box 4 is fixed to the second body member 6 without passing through the lower case 3. The junction box 4 is fixed to the second body member 6 via a bracket 8. The bracket 8 is fixed to the second body member 6 via the support member 9. The support member 9 is bolted to the second body member 6. As shown in FIGS. 2 and 3, in the rear portion of the vehicle 1, the support member 9 and the lower case 3 are fastened together to the second body member 6. The junction box 4 is covered by a cover member 10. The cover member 10 is fixed to the support member 9.

The junction box 4 is connected to the conductive member 11 on the output side. The junction box 4 and the connection port 12 are electrically connected by a conductive member 11. The conductive member 11 is provided in the case of the battery pack. The connection port 12 is provided on the outside of the lower case 3 and is fixed to the lower case 3. A connector of an electric device provided outside the lower case 3 is connected to the connection port 12. The junction box 4 outputs the electric power supplied from the battery modules 2 to the electric device connected to the connection port 12.

In the vehicle 1, the battery modules 2 and the junction box 4 are fixed to different rigid bodies. Although the battery modules 2 are fixed to the lower case 3, the junction box 4 is not fixed to the lower case 3. When the vehicle 1 vibrates, the lower case 3 vibrates with respect to the first body member 5 and vibrates with respect to the second body member 6. When the lower case 3 vibrates, the battery modules 2 and the connection port 12 fixed to the lower case 3 vibrate together with the lower case 3, but the junction box 4 not fixed to the lower case 3 vibrates relative to the lower case 3. Since the amplitudes of the battery modules 2 and the junction box 4 fluctuated by the vibration force of the vehicle 1 are different from each other, the conductive member 7 constantly receives the stress of the relative displacement during the traveling of the vehicle 1. Therefore, the conductive member 7 has a vibration absorbing structure that resists relative vibration.

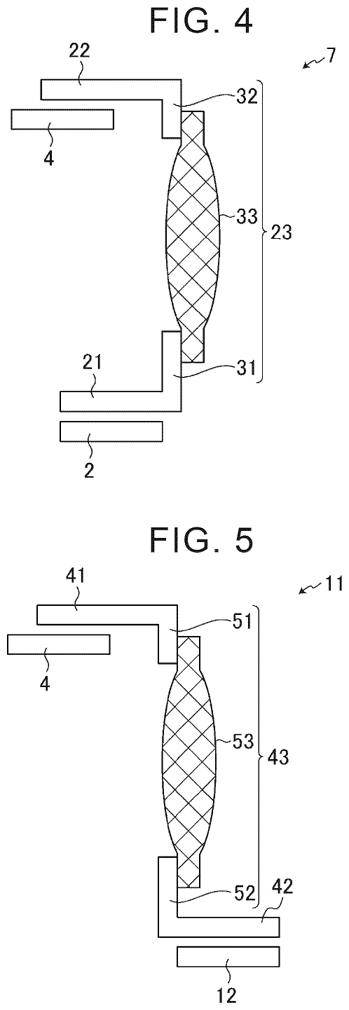

As shown in FIG. 4, the conductive member 7 has a first connection portion 21 connected to the battery module 2, a second connection portion 22 connected to the junction box 4, and an intermediate portion 23 connecting the first connection portion 21 and the second connection portion 22. The intermediate portion 23 has a vibration absorbing structure.

The first connection portion 21 constitutes a lower portion of the conductive member 7. The first connection portion 21 is a busbar connected to a terminal of the battery module 2. The first connection portion 21 includes a first horizontal portion extending in the horizontal direction.

The second connection portion 22 constitutes an upper portion of the conductive member 7. The second connection portion 22 is a busbar connected to an input terminal of the junction box 4. The second connection portion 22 includes a second horizontal portion extending in the horizontal direction.

The intermediate portion 23 is a portion of the conductive member 7 that extends in the up-down direction. The intermediate portion 23 has a first bent portion 31 bent from the first connection portion 21, a second bent portion 32 bent from the second connection portion 22, and a vibration absorbing portion 33 connecting the first bent portion 31 and the second bent portion 32.

The first bent portion 31 is bent upward in the up-down direction from the first connection portion 21. The first bent portion 31 is a busbar. The first connection portion 21 and the first bent portion 31 are a single-piece busbar.

The second bent portion 32 is bent downward in the up-down direction from the second connection portion 22. The second bent portion 32 is constituted by a busbar. The second connection portion 22 and the second bent portion 32 are a single-piece busbar.

The vibration absorbing portion 33 extends in the up-down direction between the first bent portion 31 and the second bent portion 32. The vibration absorbing portion 33 is formed of a braided wire. The vibration absorbing portion 33 is a braid of electric wires. The vibration absorbing portion 33 is a flexible portion capable of being positively displaced with respect to vibration. The vibration absorbing portion 33 is flexible and absorbs relative vibrations between the rigid bodies. The vibration absorbing portion 33 is deformed so as to absorb relative movement when the battery module 2 and the junction box 4 vibrate relatively. The first bent portion 31 and the second bent portion 32 are busbars, and the busbars has high rigidity. The vibration absorbing portion 33 is a flexible braided wire, and the braided wire has low rigidity. The vibration absorbing portion 33 has lower rigidity than the first bent portion 31 and the second bent portion 32. That is, the vibration absorbing portion 33 has lower rigidity than the first connection portion 21 and the second connection portion 22.

Since the conductive member 7 has the vibration absorbing portion 33, it is possible to reduce the stress concentration on the first bent portion 31 and the stress concentration on the second bent portion 32. Since the vibration absorbing portion 33 has flexibility against bending, the assembling property and the fastening reliability of the conductive member 7 can be ensured.

Similarly to the conductive member 7, the conductive member 11 on the output side has a vibration absorbing structure that withstands relative vibration. As shown in FIG. 5, the conductive member 11 includes a first connection portion 41 connected to the junction box 4, a second connection portion 42 connected to the connection port 12, and an intermediate portion 43 connecting the first connection portion 41 and the second connection portion 42. The intermediate portion 43 has a vibration absorbing structure.

The first connection portion 41 forms an upper portion of the conductive member 11. The first connection portion 41 is a busbar connected to the output terminal of the junction box 4. The first connection portion 41 includes a first horizontal portion extending in the horizontal direction.

The second connection portion 42 forms a lower portion of the conductive member 11. The second connection portion 42 is a busbar connected to a terminal of the connection port 12. The second connection portion 42 includes a second horizontal portion extending in the horizontal direction.

The intermediate portion 43 is a portion of the conductive member 11 that extends in the up-down direction. The intermediate portion 43 has a first bent portion 51 bent from the first connection portion 41, a second bent portion 52 bent from the second connection portion 42, and a vibration absorbing portion 53 connecting the first bent portion 51 and the second bent portion 52.

The first bent portion 51 is bent downward in the up-down direction from the first connection portion 41. The first bent portion 51 is a busbar. The first connection portion 41 and the first bent portion 51 are a single-piece busbar.

The second bent portion 52 is bent upward in the up-down direction from the second connection portion 42. The second bent portion 52 is a busbar. The second connection portion 42 and the second bent portion 52 are a single-piece busbar.

The vibration absorbing portion 53 extends in the up-down direction between the first bent portion 51 and the second bent portion 52. The vibration absorbing portion 53 is formed of a braided wire. The vibration absorbing portion 53 is a braid of electric wires. The vibration absorbing portion 53 is a flexible portion capable of being positively displaced with respect to vibration. The vibration absorbing portion 53 is flexible and absorbs relative vibrations between the rigid bodies. The vibration absorbing portion 53 is deformed so as to absorb relative movement when the junction box 4 and the connection port 12 vibrate relatively. The first bent portion 51 and the second bent portion 52 are busbars, and the busbars have high rigidity. The vibration absorbing portion 53 is a flexible braided wire, and the braided wire has low rigidity. The vibration absorbing portion 53 has lower rigidity than the first bent portion 51 and the second bent portion 52. That is, the vibration absorbing portion 53 has lower rigidity than the first connection portion 41 and the second connection portion 42.

Since the conductive member 11 has the vibration absorbing portion 53, it is possible to reduce the stress concentration on the first bent portion 51 and to reduce the stress concentration on the second bent portion 52. Since the vibration absorbing portion 53 has flexibility against bending, the assembling property and the fastening reliability of the conductive member 11 can be ensured.

As described above, according to the embodiment, since the conductive member 7 and the conductive member 11 have the vibration absorbing structure, the stress concentration can be avoided, and the resistance to repeated stress is improved.

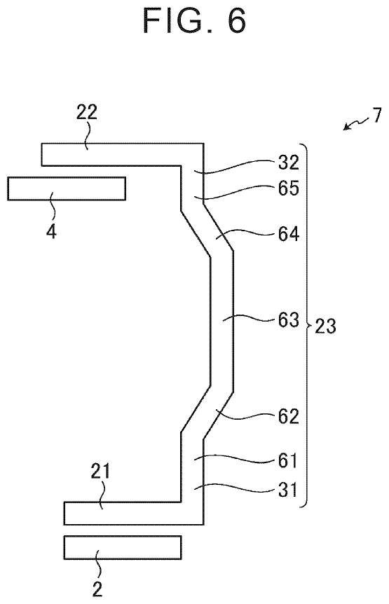

The vibration absorbing structure provided in the conductive member 7 and the conductive member 11 is not limited to a braided wire. For example, the conductive member 7 and the conductive member 11 may be entirely constituted by a busbar. As shown in FIG. 6, the conductive member 7 has an intermediate portion 23 formed of a busbar. The intermediate portion 23 includes a first bent portion 31, a second bent portion 32, a first vertical portion 61, a first tilted portion 62, a second vertical portion 63, a second tilted portion 64, and a third vertical portion 65.

The first vertical portion 61 extends upward in the up-down direction from the first bent portion 31. The first tilted portion 62 is tilted with respect to the up-down direction upward from the first vertical portion 61. The second vertical portion 63 extends upward and downward from the first tilted portion 62. The second tilted portion 64 is tilted with respect to the up-down direction upward from the second vertical portion 63. The third vertical portion 65 extends in the up-down direction from the second tilted portion 64 toward the second bent portion 32.

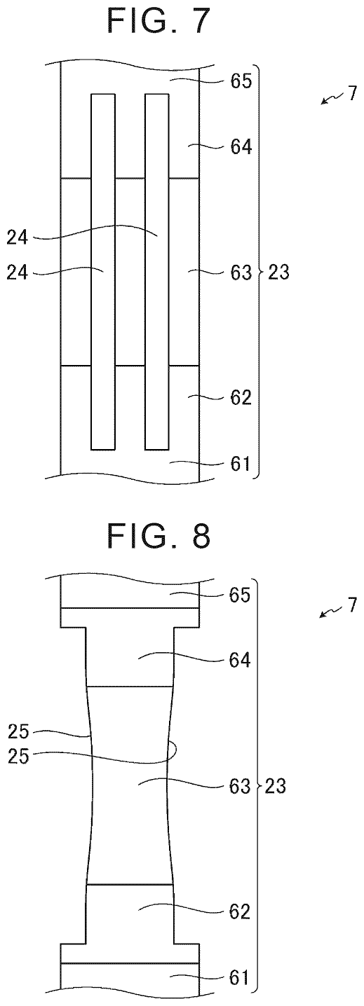

Further, the intermediate portion 23 may be provided with a slit or a constricted portion as a structure for relaxing stress concentration. As shown in FIG. 7, the intermediate portion 23 has slits 24 extending in the up-down direction. The slit 24 is provided over the first tilted portion 62, the second vertical portion 63, and the second tilted portion 64. As shown in FIG. 8, the intermediate portion 23 is provided with a constricted portion 25 having a minimum width at the center portion in the up-down direction. The modification described with reference to FIGS. 6 to 8 is also applicable to the conductive member 11.

What is claimed is:

1. A vehicle comprising:
a battery module composed of a stack of a plurality of battery cells;
a lower case that houses the battery module and to which the battery module is fixed;
a junction box disposed above the battery module;
a first body member to which the lower case is fixed;
a second body member to which the junction box is fixed; and
a conductive member that electrically connects the battery module and the junction box, wherein
the conductive member includes
a first connection portion connected to the battery module,
a second connection portion connected to the junction box, and
an intermediate portion connecting the first connection portion and the second connection portion, and
the intermediate portion has lower rigidity than the first connection portion and the second connection portion.

2. The vehicle according to claim 1, wherein:
the first connection portion includes a first horizontal portion extending in a horizontal direction;
the second connection portion includes a second horizontal portion extending in the horizontal direction;
the intermediate portion includes
a first bent portion bent upward in an up-down direction from the first horizontal portion,
a second bent portion bent downward in the up-down direction from the second horizontal portion, and
a vibration absorbing portion extending in the up-down direction between the first bent portion and the second bent portion; and
the vibration absorbing portion is deformed so as to absorb relative movement between the first connection portion and the second connection portion when the battery module and the junction box vibrate relative to each other.

3. The vehicle according to claim 2, wherein:
the first horizontal portion and the first bent portion are a single-piece busbar;
the second horizontal portion and the second bent portion are a single-piece busbar and
the vibration absorbing portion is a braid of electric wires.

4. The vehicle according to claim 2, wherein:
the conductive member is a busbar; and
the vibration absorbing portion includes
a first vertical portion extending upward in the up-down direction from the first bent portion,
a first tilted portion tilted with respect to the up-down direction upward from the first vertical portion,
a second vertical portion extending upward in the up-down direction from the first tilted portion,
a second tilted portion tilted with respect to the up-down direction upward from the second vertical portion, and
a third vertical portion extending in the up-down direction from the second tilted portion toward the second bent portion.

5. The vehicle according to claim 4, wherein the first tilted portion, the second vertical portion, and the second tilted portion are provided with a slit extending in the up-down direction.
